(19) United States
(12) Patent Application Publication
(10) Pub. No.: US 2026/0267851 A1
(43) Pub. Date: Sep. 10, 2026

(54) AI-BASED MEMORY RECALL CONTENT CREATION SYSTEM AND METHOD

(71) Applicant: WONDERFUL PLATFORM LIMITED, Seoul (KR)

(72) Inventors: SEUNG YUB KOO, Gyeonggi-do (KR); SEONG TAEK HWANG, Gyeonggi-do (KR); JOON GU HEO, Seoul (KR); SU MIN KIM, Seoul (KR); HEE EUN JO, Seoul (KR)

(21) Appl. No.: 19/332,400

(22) Filed: Sep. 18, 2025

(30) Foreign Application Priority Data
Mar. 4, 2025 (KR) 10-2025-0027560

(51) Int. Cl. G06F 16/242

(52) U.S. Cl. CPC G06F 16/242

(57) ABSTRACT

An artificial intelligence (AI)-based memory recall content creation system includes an information collection unit to receive and collect a source information provided by a content creation requester, a content generation unit to receive the source information from the information collection unit and generate a content information using the received source information, and a query generation unit to generate query information related to the content information being played and provide the generated query information to a target content user when the content information is reproduced through a terminal device. There are effects of stimulating cognitive ability and providing emotional stability by automatically creating personalized memory recall content using AI technology based on past photos of a target content user (senior) and descriptive text provided by a content creation requester (caregiver), and eliciting real-time conversation with the target content user while the content is being viewed.

### CROSS-REFERENCE TO RELATED APPLICATION AND CLAIM OF PRIORITY

This application claims the benefit under 35 USC § 119 of Korean Patent Application No. 10-2025-0027560 filed on Mar. 4, 2025, in the Korean Intellectual Property Office, the entire disclosure of which is incorporated herein by reference for all purposes.

### BACKGROUND

### 1. Field

The present disclosure relates to an artificial intelligence (AI)-based memory recall content creation system and method.

### 2. Description of the Related Art

The present invention was supported by the national research and development program (Project identification number: 1415190005; Project number: P 0025661; Department name: Ministry of Trade, Industry and Energy; Project management (professional) organization name: Korea Institute for Advancement of Technology; Research program title: Industrial Technology International Cooperation; Research project title: Human care solutions based on AI data analysis and monitoring systems; Contribution ratio: 100%; Project execution organization name: WONDERFUL PLATFORM LIMITED; Research period: 2023.07.01-2026.06.30) awarded by Ministry of Trade, Industry and Energy. The Government has certain rights in the invention.

As the number of older people increases, cognitive decline, increased depression and increased incidence of dementia in seniors (older adults) are emerging social issues.

In particular, as the elderly lack social interaction and have less time talking and sharing memories with family members compared to the past, not only emotional isolation but also memory and cognitive decline are growing concerns.

To address these issues, attention is paid to an approach to provide emotional stability and cognitive stimulation by encouraging seniors to recall past experiences or precious memories.

Recalling past experiences may help seniors to recollect familiar and meaningful memories, eliciting positive emotions and promoting brain activation, thereby contributing to prevent and slow down dementia.

For example, there is reminiscence therapy that allows seniors to share related stories with caregivers while seeing old photos or videos.

This method has advantages of providing emotional stability to seniors and strengthening bonds with caregivers.

Additionally, welfare facilities or nursing homes provide cognitive rehabilitation programs involving listening to old popular songs or sharing stories related to historical events for each group.

Meanwhile, with the development of digital technology, there are some emerging services that help individuals to create digital content using photos and video data.

Smartphone-based image editing applications support automatic creation and easy sharing of slideshows of images from users' input photos and descriptive texts.

Furthermore, there are an increasing number of commercial services that reproduce specific persons' voices or provide natural voice guidance and conversations using text-to-speech (TTS) and natural language processing (NLP).

However, a majority of existing technologies require caregivers to edit videos and photos, write descriptions and record the contents of the descriptions or enter them in the form of subtitles, and this causes inconvenience.

Moreover, they are not good at interacting with seniors in real time while the seniors are watching videos or generating personalized questions according to the seniors' reactions to naturally elicit past memories.

Recently, with the rapid development of generative AI technology, technology that automatically creates various types of content such as text, image, voice or video is emerging.

Its typical examples include audio video combiners based on GPT family language models or DeepFake.

However, there is still lack of a general system that uses generative AI technology to create personalized memory recall content for older adults and naturally elicits past experiences through real-time conversation while the older adults are watching videos to provide emotional stability and cognitive stimulation effects.

### SUMMARY

The present disclosure is designed to solve the above-described problems, and therefore the present disclosure is directed to providing an artificial intelligence (AI)-based memory recall content creation system and method that automatically creates personalized memory recall content using AI technology based on past photos of a target content user (a senior) and descriptive text provided by a content creation requester (caregiver), and elicits real-time conversation with the target content user while the content is being viewed, in order to stimulate cognitive ability and provide emotional stability.

The present disclosure is further directed to naturally eliciting past memories of the target content user through real-time question/answer with the target content user while the content is being viewed, and utilizing the details of the corresponding conversation in the subsequent memory recall process, thereby providing richer emotional interaction and cognitive stimulation effects.

The objectives of the present disclosure are not limited thereto, and these and other objectives will be clearly understood by those skilled in the art from the following description.

To achieve the above-described objectives, an embodiment of the present disclosure provides an artificial intelligence (AI)-based memory recall content creation system that generates and provides content information for recalling memories of a target content user by using source information provided by a content creation requester, the system including an information collection unit to receive and collect the source information provided by the content creation requester; a content generation unit to receive the source information from the information collection unit and generate the content information using the received source information; and a query generation unit to generate query information related to the content information being played and provide the generated query information to the target content user when the content information is reproduced through a terminal device.

Additionally, provided is the AI-based memory recall content creation system, wherein the information collection unit receives and collects response information of the target content user to the query information provided to the target content user, and wherein the content generation unit updates the content information using updated source information in which the response information is added to the source information.

Additionally, provided is the AI-based memory recall content creation system further including a generative AI module unit to receive the query information from the query generation unit and generate query supplemental information based on an auto-generated prompt.

Meanwhile, another embodiment of the present disclosure provides an AI-based memory recall content creation method that generates and provides content information for recalling memories of a target content user by using source information provided by a content creation requester, the method including the steps of (a) receiving and collecting, by an information collection unit of an AI-based memory recall content creation system, the source information provided by the content creation requester; (b) receiving, by a content generation unit of the AI-based memory recall content creation system, the source information from the information collection unit and generating the content information using the received source information; and (c) generating, by a query generation unit of the AI-based memory recall content creation system, query information related to the content information being played and providing the generated query information to the target content user when the content information is reproduced through a terminal device.

Additionally, provided is the AI-based memory recall content creation method, wherein the information collection unit receives and collects response information of the target content user to the query information provided to the target content user, and wherein the content generation unit updates the content information using updated source information in which the response information is added to the source information.

Additionally, provided is the AI-based memory recall content creation method further including the step of (d) receiving, by a generative AI module unit of the AI-based memory recall content creation system, the query information from the query generation unit and generating query supplemental information based on an auto-generated prompt.

According to an embodiment of the present disclosure, there are effects of stimulating cognitive ability and providing emotional stability by automatically creating personalized memory recall content using AI technology based on past photos of the target content user (senior) and descriptive text provided by the content creation requester (caregiver), and eliciting real-time conversation with the target content user while the content is being viewed.

Additionally, the present disclosure has effects of providing richer emotional interaction and cognitive stimulation effects by naturally eliciting past memories of the target content user through real-time question/answer with the target content user while the content is being viewed, and utilizing the details of the corresponding conversation in the subsequent memory recall process.

### BRIEF DESCRIPTION OF THE DRAWINGS

FIG. 1 is a block diagram of an artificial intelligence (AI)-based memory recall content creation system according to an embodiment of the present disclosure.

FIGS. 2 and 3 are flowcharts of an AI-based memory recall content creation method according to another embodiment of the present disclosure.

### DETAILED DESCRIPTION

Hereinafter, certain embodiments of the present disclosure will be described in detail through the exemplary drawings. In affixing the reference numerals to the elements in each drawing, it should be noted that identical elements are given as identical numbers as possible although they are depicted in different drawings. Additionally, in describing the present disclosure, when it is determined that a detailed description of a related known element or function may obscure the subject matter of the present disclosure, its detailed description is omitted.

Furthermore, in describing the elements of the present disclosure, the terms first, second, A, B, (a), (b), etc. may be used. These terms are used to distinguish one element from another, and the nature, sequence or order of the corresponding element is not limited by the term. When an element is referred to as being “connected to”, “coupled to” or “linked to” another element, it should be understood that it can be directly connected or linked to the other element, but another element may be “connected”, “coupled” or “linked” between the elements.

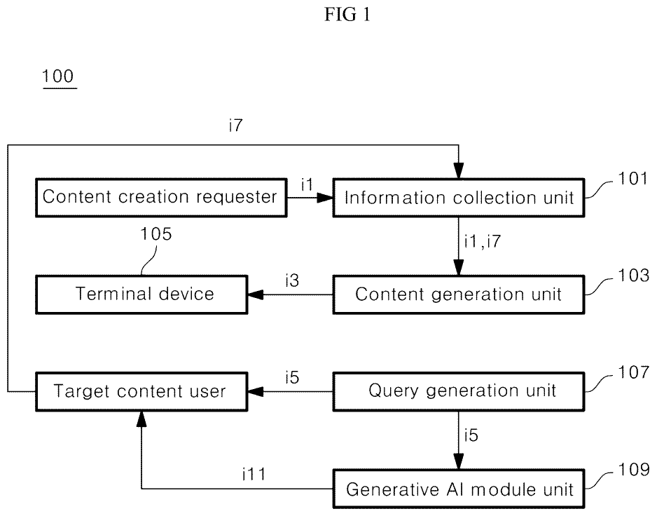

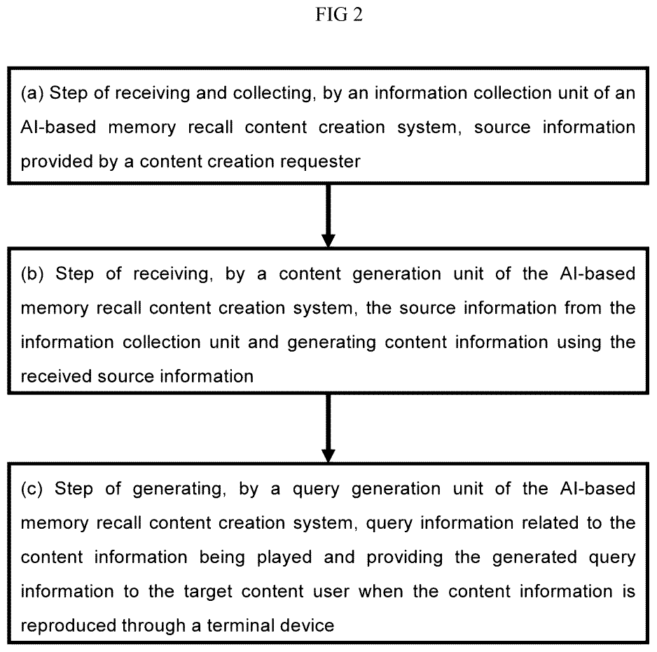

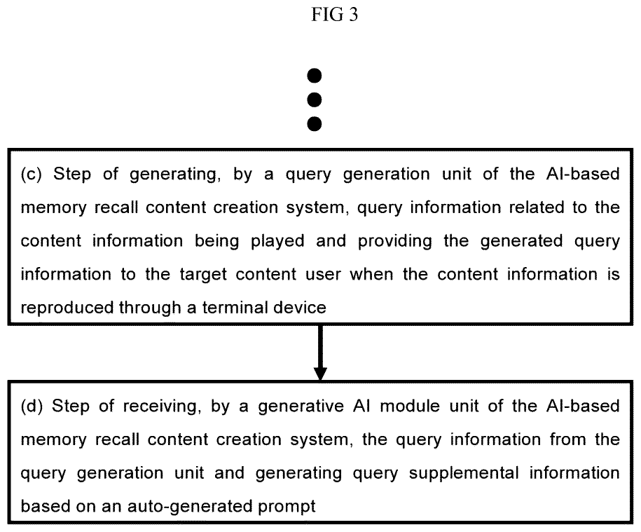

FIG. 1 is a block diagram of an artificial intelligence (AI)-based memory recall content creation system according to an embodiment of the present disclosure. FIGS. 2 and 3 are flowcharts of an AI-based memory recall content creation method according to another embodiment of the present disclosure.

As shown in FIGS. 1 to 3, an embodiment of the present disclosure provides the system 100 that generates and provides content information (i3) for recalling memories of a target content user by using source information (i1) provided by a content creation requester, and the system 100 includes an information collection unit 101 to receive and collect the source information (i1) provided by the content creation requester; a content generation unit 103 to receive the source information (i1) from the information collection unit 101 and generate the content information (i3) using the received source information (1); and a query generation unit 107 to generate query information (i5) related to the content information (i3) being played and provide the generated query information to the target content user when the content information (i3) is reproduced through a terminal device 105.

Hereinafter, each component will be described in detail.

### Information Collection Unit 101

The information collection unit 101 receives and collects the source information (i1) provided by the content creation requester.

The content creation requester may be, for example, a caregiver of the target content user who is a senior.

The content creation requester may upload the source information (i1) onto the information collection unit 101 using the terminal, for example, a smartphone, a tablet or a PC.

The source information (i1) is information related to the target content user, and the source information (i1) may include, for example, image information such as photos, video information such as videos, audio information such as music/voice or text information that describes photos/videos/music.

The information collection unit 101 may have a memory to store the collected source information (i1).

### Content Generation Unit 103

The content generation unit 103 receives the source information (i1) from the information collection unit 101.

The content generation unit 103 generates the content information (i3) using the received source information (i1).

The content information (i3) generated by the content generation unit 103 may include, for example, video information including voice information (narration information).
Examples of modules that constitutes the content generation unit 103 are as follows.
\textcircled{1}Image analysis and alignment module
Example of model
OpenCV, Contrastive Language-Image Pretraining (CLIP), You Only Look Once (YOLO)
Function
Analyze image quality of image information, for example, uploaded photos, and enhance image quality if necessary (for example, upscaling low-resolution photos)
Automatically arrange photos in a descending order of relevance by analyzing similarity between photos
Place photos in which the target content user is centered with priority by using facial recognition and object detection
Connect specific photos to text information describing the photos to order the photos in a sequence when the photos contain the text information
\textcircled{2}Text analysis and scenario generation module
Example of Model
GPT-4, Bidirectional Encoder Representations from Transformers (BERT), Text-to-Text Transfer Transformer (T5)
Function
Extract a core keyword by analyzing text information which is description entered by the content creation requester (for example, “2010 Gyeongju trip”, “cherry blossom viewing”)
Naturally connect videos in a sequence by analyzing the context
Automatically generate an additional description using AI, one of the exemplary models when description is insufficient (for example, “This is a famous tourist attraction in Gyeongju”)
Make a personalized narration, taking into account the target content user's interests (for example, “This is the place where rapeseed flowers that my grandmother loved were in full bloom”)
\textcircled{3}AI-based image generation module
Example of model
RunwayML, Pika Labs, D-ID, Deepbrain AI
Function
Automatically convert image information, for example, uploaded photos to a video slideshow together with smooth transition effect
Automatically recommend and add background music (for example, “calm classical”, “travel theme music”)
Apply animation effects best suited for specific photos (for example, zoom in/ zoom out, fade in/out)
Recommend a video style according to the details of description (for example, “old film feeling”, “bright and vibrant style”)
\textcircled{4}Speech synthesis and narration addition module
Example of model
ElevenLabs, Microsoft Azure TTS, Google WaveNet, Amazon Polly
Function
Convert description text entered by the content creation requester into natural voice and add it
Select a preferred voice for the target content user (for example, family member's voice, favorite celebrity's tone)
Convert a sentence into emotional tone to provide immersion (for example, “You were so happy back then, weren't you?”)

### Query Generation Unit 107

The query generation unit 107 generates the query information (i5) related to the content information (i3) being played and provides it to the target content user when the content information (i3) is reproduced through the terminal device 105.

The query generation unit 107 may include a ‘question template and pattern matching module’.

The function of the question template and pattern matching module and example sentence are as follows:
Function
Create a personalized question by retrieving a question template associated with a specific keyword
Naturally connect based on what the target content user has mentioned in past conversation
Apply emotional elements (for example, “How did you feel at that time?”, “Do some memories pop into your mind?”)
Example sentence
Create a question “Do you remember the person you were with back then?” based on the keyword “Gyeongju trip”
When a keyword “went with grandson” is added →“Where was your grandson's favorite place?”

Meanwhile, in the AI-based memory recall content creation system 100 according to an embodiment of the present disclosure, the information collection unit 101 may receive and collect response information (i7) of the target content user to the query information (i5) provided to the target content user, and the content generation unit 103 may update the content information (i3) using updated source information (i9) in which the response information (i7) is added to the source information (i1).

The target content user may upload the response information (i7) onto the information collection unit 101 using the terminal, for example, a smartphone, a tablet or a PC.

Furthermore, the AI-based memory recall content creation system 100 according to an embodiment of the present disclosure may further include a generative AI module unit 109 to receive the query information (i5) from the query generation unit 107 and generate query supplemental information (i11) through an auto-generated prompt.

Here, the query supplemental information (i11) may include, for example, information associated with an additional question or information associated with related description.

The query supplemental information (i11) is provided to the target content user.

The target content user may update the response information (i7) according to the query supplemental information (i11), and the updated response information (i7) may be collected and stored by the information collection unit 101.

The functions of modules that constitute the generative AI module unit 109 and example sentences are as follows
\textcircled{1} Prompt generation and query optimization module
Function
Convert the received question (query information (i5)) from the query generation unit 107 into more natural way of speaking by analyzing the question
Generate a follow-up question by predicting the target content user's reaction
Connect the flow of conversation smoothly (to avoid repeating a previous question)
Example sentence
Question (query information (i5)): “What is the most memorable moment of this trip?”
Generative AI supplemental question (query supplemental information (i11)): “What was the most memorable moment at that time? Do you have the most favorite one of the photos taken at that time?”
\textcircled{2} Personalized question supplementation and sentiment analysis module function
Adjust the tone of the question by analyzing the target content user's emotions (joy, sadness, surprise and so on)
Convert the basic question into more emotional way of speaking
Create an additional leading question when the target content user gives a short answer
Example Sentence
Question (query information (i5)): “What did you like best?”
Generative AI supplemental question (query supplemental information (i11)): “That was really great! Could you tell me a little more about what happened back then?”

Meanwhile, another embodiment of the present disclosure provides a method that generates and provides the content information (i3) for recalling memories of the target content user by using the source information (i1) provided by the content creation requester, and the method includes the steps of (a) receiving and collecting, by the information collection unit 101 of the AI-based memory recall content creation system 100, the source information (i1) provided by the content creation requester; (b) receiving, by the content generation unit 103 of the AI-based memory recall content creation system 100, the source information (i1) from the information collection unit 101 and generating the content information (i3) using the received source information (i1); and (c) generating, by the query generation unit 107 of the AI-based memory recall content creation system 100, the query information (i5) related to the content information (i3) being played and providing the generated query information to the target content user when the content information (i3) is reproduced through the terminal device 105.

Additionally, in the AI-based memory recall content creation method according to another embodiment of the present disclosure, the information collection unit 101 may receive and collect the response information (i7) of the target content user to the query information (i5) provided to the target content user, and the content generation unit 103 may update the content information (i3) using the updated source information (i9) in which the response information (i7) is added to the source information (i1).

Furthermore, the AI-based memory recall content creation method according to another embodiment of the present disclosure may further include the step of (d) receiving, by the generative AI module unit 109 of the AI-based memory recall content creation system 100, the query information (i5) from the query generation unit 107 and generating the query supplemental information (i11) based on the auto-generated prompt. The technical feature and function of each of the entities that perform the steps of the AI-based memory recall content creation method according to another embodiment of the present disclosure are the same as those of the AI-based memory recall content creation system 100, and its detailed description is omitted.

As has been described hereinabove, according to an embodiment of the present disclosure, there are effects of stimulating cognitive ability and providing emotional stability by automatically creating personalized memory recall content using AI technology based on past photos of the target content user (senior) and descriptive text provided by the content creation requester (caregiver), and eliciting real-time conversation with the target content user while the content is being viewed.

Additionally, the present disclosure has effects of providing richer emotional interaction and cognitive stimulation effects by naturally eliciting past memories of the target content user through real-time question/answer with the target content user while the content is being viewed, and utilizing the details of the corresponding conversation in the subsequent memory recall process.

Although all the elements in the embodiments of the present disclosure have been hereinabove described as being combined into one or working in combination, the present disclosure is not necessarily limited to these embodiments. That is, within the intended scope of the present disclosure, all the elements may be selectively combined into one or more and work in combination.

The technical aspects of the present disclosure are described by way of illustration, and it is obvious to persons having ordinary skill in the technical field pertaining to the present disclosure to make modifications and changes thereto without departing from the essential features of the present disclosure. Therefore, the disclosed embodiments of the present disclosure are provided to describe the technical aspects of the present disclosure, but not intended to be limiting, and the scope of the present disclosure is not limited by these embodiments. The scope of protection of the present disclosure should be interpreted by the appended claims, and it should be understood that all the technical aspects within the equivalent scope are included in the scope of protection of the present disclosure.

What is claimed is:

1. An artificial intelligence (AI)-based memory recall content creation system comprising:
an information collection unit configured to receive and collect a source information provided by a content creation requester;
a content generation unit configured to receive the source information from the information collection unit and generate a content information using the received source information; and
a query generation unit configured to generate query information related to the content information being played and provide the generated query information to a target content user when the content information is reproduced through a terminal device.

2. The AI-based memory recall content creation system according to claim 1, wherein the information collection unit is configured to receive and collect response information of the target content user to the query information provided to the target content user, and
the content generation unit is configured to update the content information using updated source information in which the response information is added to the source information.

3. The AI-based memory recall content creation system according to claim 1, further comprising:
a generative AI module unit configured to receive the query information from the query generation unit and generate query supplemental information based on an auto-generated prompt.

4. An artificial intelligence (AI)-based memory recall content creation method, the method comprising:
receiving and collecting, by an information collection unit of an AI-based memory recall content creation system, a source information provided by a content creation requester;
receiving, by a content generation unit of the AI-based memory recall content creation system, the source information from the information collection unit and generating a content information using the received source information; and
generating, by a query generation unit of the AI-based memory recall content creation system, query information related to the content information being played and providing the generated query information to the target content user when the content information is reproduced through a terminal device.

5. The AI-based memory recall content creation method according to claim 4, wherein the information collection unit is configured to receive and collect response information of the target content user to the query information provided to the target content user, and
wherein the content generation unit is configured to update the content information using updated source information in which the response information is added to the source information.

6. The AI-based memory recall content creation method according to claim 4, further comprising:
receiving, by a generative AI module unit of the AI-based memory recall content creation system, the query information from the query generation unit and generating query supplemental information based on an auto-generated prompt.
